(19) United States
(12) Patent Application Publication
(10) Pub. No.: US 2025/0188104 A1
(43) Pub. Date: Jun. 12, 2025

(54) Sequential One-Pot Synthesis of Alkylidyne and Alkylidene Catalysts

(71) Applicant: THE UNIVERSITY OF FLORIDA RESEARCH FOUNDATION, INC., Gainesville, FL (US)

(72) Inventors: Adam S. Veige, Gainesville, FL (US); Park Boeck, Gainesville, FL (US)

(21) Appl. No.: 18/971,264

(22) Filed: Dec. 6, 2024

Related U.S. Application Data
(60) Provisional application No. 63/606,894, filed on Dec. 6, 2023.

(51) Int. Cl. C07F 11/00

(52) U.S. Cl. CPC C07F 11/00

(57) ABSTRACT

A method of preparing a tetraanionic pincer ligand supported metallacycloalkylene complex in one pot, the method including admixing at low temperature a solution of [^{t}BuOCO]H₃ and a solution of (^{t}BuO)₃W≡CC(CH₃)₃ in a second solvent to form a first reaction mixture, warming the first reaction mixture, removing at least a portion of solvent from the first reaction mixture to provide a second reaction mixture, admixing the second reaction mixture and a solvent to form a third reaction mixture, admixing at low temperature the third reaction mixture and a base to form a fourth reaction mixture, warming the fourth reaction mixture to form a fifth reaction mixture; removing at least a portion of the third solvent from the fifth reaction mixture to provide a sixth reaction mixture; washing the sixth reaction mixture with a fifth solvent and removing at least a portion of the fifth solvent to form a seventh reaction mixture; admixing the seventh reaction mixture with a sixth solvent to provide an eighth reaction mixture; cooling the eighth reaction mixture and admixing the eighth reaction mixture with methyl trifluoromethansulfonate to form a ninth reaction mixture; warming the ninth reaction mixture, and admixing a substituted alkyne with the ninth reaction mixture to form the tetraanionic pincer ligand supported metallacycloalkylene complex (1).

### STATEMENT OF GOVERNMENT SUPPORT

This invention was made with government support under Grant No. 2154377 awarded The National Science Foundation. The government has certain rights in the invention

### FIELD

The disclosure is generally directed to a one pot synthesis of alkylidyne and alkylidene catalysts. More particularly, the disclosure is generally directed to tetra-anionic pincer-ligand supported metallacycloalkylene complexes by the addition of an alkyne to a trianionic pincer ligand supported metal-alkylidyne complex.

### BACKGROUND

High oxidation state alkylidene and alkylidyne metal complexes have been known for about 40 years. Alkene and alkyne metathesis via these metal complexes has been studied extensively. Alkylidyne metal complexes have been studied to a lesser extent than their alkylidene analogues, but they are of particular interest for their potential to promote nitrile-alkyne cross metathesis (NACM), which constitutes a potentially valuable tool to prepare novel alkynes from readily accessible nitriles.

Metal-alkylidynes contain a metal-carbon triple bond. Metal-alkylidynes, having a metal in its highest oxidation state, are known as Schrock-type metal-alkylidynes, and have been widely investigated. In high-oxidation state metal-alkylidynes, the alkylidyne carbon is a 6-electron donor that provides TT-donation to the metal center. In spite of extensive IT-donation, most high-oxidation state metal-alkylidynes arc electron deficient and must be stabilized by additional ligands.

Schrock-type metal-alkylidynes are generally formed by the deprotonation of an α-CH, where a base deprotonates the α-carbon to form an alkylidyne from the alkylidene, or by an α-elimination reaction, in which bulky alkyl groups promote deprotonation of the α-CH to release steric crowding during formation of metal-alkylidynes. In rare cases, these complexes have been formed by a metathesis reaction between an alkyne and a metal-metal triple bond, or by a reductive recycle series of reactions, where a gem-dichloride reacts with a metal complex, to form a mixture of a metal chloride complex and a metal alkylidene, followed by reduction of the metal chloride complex back to the original metal complex.

A catalytic NACM was reported by Geyer et al., J. Ani. Chem. Soc. 2007, 129, 3800-1, where a tungsten-nitride of the form (RO)₃W≡N was found to reversibly convert to the corresponding metal-alkylidyne upon treatment with an alkyne. Unfortunately, rates of reaction were very slow and a very limited substrate scope was observed. Using a novel titanium alkylidene-alkyl complex (PNP)Ti═CH^{t}Bu (CH₂^{t}Bu), where PNP is a phosphorous-nitrogen-phosphorous tridentate pincer-type ligand, and bulky nitriles, NACM was achieved. However, the catalyst required an external electrophile to liberate the alkyne, as reported by Bailey et al., J. Am. Chem. Soc. 2007, 129, 2234-5.

Polyacetylenes are organic polymers that can display electrical conductivity, paramagnetic susceptibility, optical nonlinearity, photoconductivity, gas permeability, liquid-crystallinity, and chain-helicity. Polymerization of acetylenes employs a transition metal catalyst, generally with a cocatalyst. High molecular weight polyacetylenes (>106 g/mol) have been produced from catalysts, such as M(CO)₆—CCl₄-hv(M=Mo, W), where the active species has been determined to be a metal-alkylidene, with polymerization involving a metathesis pathway. The metal-alkylidyne, (R₃CO)₃W≡CC(CH₃)₃, has been shown to promote alkyne metathesis and alkyne polymerization, as reported by Mortreux et al., J. Mol. Catal. A: Chem. 1995, 96, 95-105, where the product composition varied with the substitution. Polymerization was shown to be the exclusive path only with phenyl or trimethylsilyl monosubstituted acetylenes. The metal-alkylidyne, H₅C₆C≡W(CO)₄Br, promotes a slow alkyne polymerization without alkyne metathesis as reported by Katz et al., J. Am. Chem. Soc. 1984, 106, 2659-68, but only low monomer conversion is observed after periods of days.

One might expect that OCO pincer ligand supported metal-alkylidynes should be well suited as metathesis or polymerization catalysts for alkynes, as: the trianionic nature of the OCO pincer ligand allows access to a +6 oxidation state required for a metal-alkylidyne; the rigid planarity of the OCO pincer ligand imposes geometric restraints around the metal center, which might permit an increase in reactivity; and the strong M-C bond should distort the metal-alkylidyne out of the plane of the ligand, which might further increase the reactivity of the resulting complex.

The polymerization of monomers into cyclic polymers that do not contain end groups provides polymers that demonstrate unique physical properties. For example, the density, refractive index, Tg, viscoelasticity, solution dynamics, and surface properties of cyclic polymers all differ from those of their more common linear analogs. Despite research in this area for over half a century there still remains a lack of knowledge regarding the properties and fundamental behavior of cyclic analogs of important commercial polymers. Ring closing of large chains is one method of creating cyclic polymers, but requires infinite dilution conditions to be efficient, thus precluding large scale synthesis. Intermolecular cross coupling of two separate chains inevitably leads to linear impurities, where even trace noncyclic impurities can have pronounced effects on the physical properties of a sample. Exhaustive purification to remove linear byproducts, biphasic conditions, or preparatory scale GPC is often necessary and limits the large scale synthesis of cyclic polymers.

Ring-expansion polymerization is another method for accessing cyclic polymers. The mechanism involves the insertion of monomer into a growing ring at a labile bond, such as a metal-carbon or metal-oxygen bond. Ring expansion method does not suffer the same stringent concentration limitations as ring closure, making it an appealing approach for synthesizing cyclic polymers. A dibutyltin catalyst disclosed in Kricheldorf Macromolecules 1995, 28, 6718-6725, was an early example of this type of polymerization with lactones. In many cases, catalysts must be tuned to specific monomers. Ring-expansion olefin metathesis polymerization (REMP), introduced by Grubbs, and described in Bielawski et al., Science 2002, 297, 2041-2044, and Xia, Y. et al., J. Am. Chem. Soc. 2009, 131, 2670-2677 addresses producing cyclic polymers efficiently. While the ring-expansion method of creating cyclic polymers is much preferred to the post-polymerization processing required in ring-closure for larger scale syntheses, ring-expansion can suffer from backbiting as the degree of polymerization increases and linear polymers can form during the reaction if trace linear alkenes are present in the monomer feedstock.

Additionally, REMP catalyst systems require a cyclic monomer, for example cyclooctene and its derivatives. It would be beneficial to employ more readily available and cheaper substrates. Thus, a longstanding general challenge in polymer chemistry is to synthesize cyclic polymers efficiently, with diverse compositions, high purity, high molecular weights, and from readily available and inexpensive monomers. U.S. Pat. No. 9,206,266 discloses tridentate pincer ligand supported metal-alkylidyne and metallacycloalkylene complexes for alkyne polymerization. However, it would be beneficial to provide a one-pot synthesis of tridentate pincer ligand supported metal-alkylidyne and metallacycloalkylene complexes.

### SUMMARY

The disclosure provides methods of preparing a tetraanionic pincer ligand supported metallacycloalkylene complex (1), comprising admixing a second reaction mixture comprising compound (7) and a third solvent to form a third reaction mixture and cooling the third reacting mixture to a third temperature in a range of about −78° C. to about 0° C.; admixing the third reaction mixture and a base at the third temperature to form a fourth reaction mixture; warming the fourth reaction mixture to a fourth temperature in a range of about 0° C. to about 80° C. to form a fifth reaction mixture; removing at least a portion of the third solvent from the fifth reaction mixture to provide a sixth reaction mixture; washing the sixth reaction mixture with a fifth solvent and removing at least a portion of the fifth solvent to form a seventh reaction mixture; admixing the seventh reaction mixture with a sixth solvent to provide an eighth reaction mixture; cooling the eighth reaction mixture to a fifth temperature in a range of about −78° C. to about 0° C. and admixing at the fifth temperature the eighth reaction mixture with a solution of methyl trifluoromethansulfonate (MeOTf) in a fifth solvent to form a ninth reaction mixture; warming the ninth reaction mixture to a sixth temperature in a range of about 0° C. to about 80° C.; and admixing a substituted alkyne and the ninth reaction mixture to form a tenth reaction mixture comprising the tetraanionic pincer ligand supported metallacycloalkylene complex (1), wherein compound (7) has the structure:

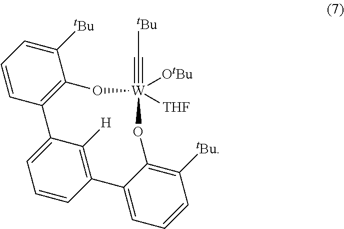

The methods can further comprise preparing the second reaction mixture comprising compound (7), by admixing at a first temperature in a range of about −78° C. to about 0° C. a solution of [tBuOCO]H₃ compound (2) in a first solvent and a solution of (tBuO)₃W≡CC(CH₃)₃ compound (3) in a second solvent to form a first reaction mixture; warming the first reaction mixture to a second temperature in a range of about 0° C. to about 80° C.; and removing at least a portion of the first solvent and the second solvent from the first reaction mixture to provide the second reaction mixture comprising compound (7), wherein compounds (2), and (3) have the structures:

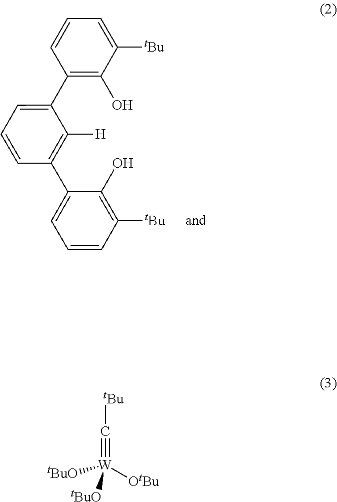

The disclosure provides methods of preparing a trianionic pincer ligand supported metal-alkylidyne complex (5), comprising: admixing a second reaction mixture comprising compound (7) and a third solvent to form a third reaction mixture and cooling the third reacting mixture to a third temperature in a range of about −78° C. to about 0° C.; admixing the third reaction mixture and an base at the third temperature to form a fourth reaction mixture; warming the fourth reaction mixture to a fourth temperature in a range of about 0° C. to about 80° C. to form a fifth reaction mixture; removing at least a portion of the third solvent from the fifth reaction mixture to provide a sixth reaction mixture; washing the sixth reaction mixture with a fifth solvent and removing at least a portion of the fifth solvent to form a seventh reaction mixture; admixing the seventh reaction mixture with a sixth solvent to provide the eighth reaction mixture; cooling the eighth reaction mixture to a fifth temperature in a range of about −78° C. to about 0° C. and admixing at the fifth temperature the eighth reaction mixture with a solution of methyl trifluoromethansulfonate (MeOTf) in a seventh solvent to form a ninth reaction mixture; and warming the ninth reaction mixture to a sixth temperature in a range of about 0° C. to about 80° C. to form a twelfth reaction mixture comprising the trianionic pincer ligand supported metal-alkylidyne complex (5), wherein compound (7) and trianionic pincer ligand supported metal-alkylidyne complex (5) have the structures:

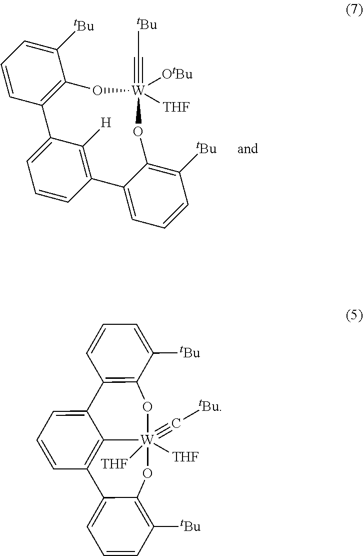

The methods can further comprise preparing the second reaction mixture comprising compound (7), by admixing at a first temperature in a range of about −78° C. to about 0° C. a solution of [tBuOCO]H₃ compound (2) in a first solvent and a solution of (tBuO)₃W≡CC(CH₃)₃ compound (3) in a second solvent to form a first reaction mixture; warming the first reaction mixture to a second temperature in a range of about 0° C. to about 80° C.; and removing at least a portion of the first solvent and the second solvent from the first reaction mixture to provide the second reaction mixture comprising compound (7), wherein compounds (2), and (3) have the structures:

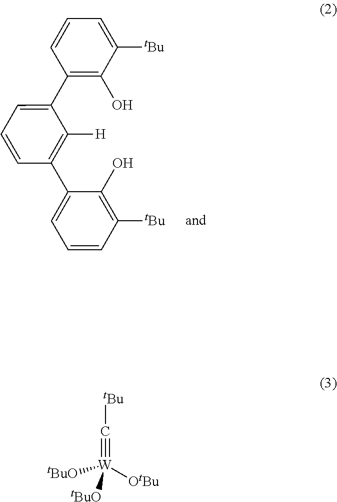

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 provides ¹H, and ¹³C NMR signals for complex (1a).

### DETAILED DESCRIPTION

International Patent Application Publication No. WO2013/085707A1, teaches the preparation of trianionic pincer ligand supported metal-alkylidyne complex. It is disclosed therein that upon addition of an alkyne to a trianionic pincer ligand supported metal-alkylidyne complex, conversion occurs into a tetra-anionic pincer-ligand supported metal-alkyne or, as shown below, a tetraanionic pincer ligand supported metallacycloalkylene complex of the structure:

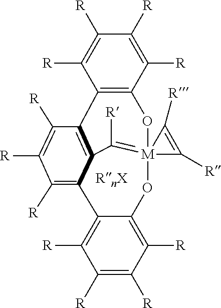

where: R is, independently, H, methyl, ethyl, n-propyl, i-propyl, n-butyl, i-butyl, t-butyl, or larger alkyl, or any other substituent that does not inhibit formation of the tetraanionic pincer-ligand supported metallacycloalkylene; R′ is, independently, methyl, ethyl, n-propyl, i-propyl, n-butyl, i-butyl, t-butyl, C₅-C₂₂ alkyl, phenyl, naphthyl, C₁₃-C₂₂ aryl, substituted aryl, or trimethylsilyl; R″ is H or methyl; X, independently, is O, N, S, P, or Se; R″, independently, can be methyl, ethyl, n-propyl, i-propyl, n-butyl, i-butyl, t-butyl, C₅-C₂₂ alkyl, phenyl, naphthyl, C₁₃-C₂₂ aryl, or two R″ are C₄-C₆ alkylene combined with a single X as a heterocycle; n is 1 to 3 depending on X; m is 1 to 2; and M is a group 5-7 transition metal. When R′ is substituted aryl, one or more substituents can be fluoro, C₁-C₃ alkoxy, or trifluoromethyl.

The tetra-anionic pincer-ligand supported metallacycloalkylene complex (1) is a metallacyclopropylene complex formed by the addition of an alkyne to a trianionic pincer ligand supported metal-alkylidyne complex (5).

The disclosure provides methods of preparing a tetraanionic pincer ligand supported metallacycloalkylene complex (1). The methods generally include:
(i) admixing at a first temperature in a range of about −78° C. to about 0° C. a solution of [^{t}BuOCO]H₃ compound (2) in a first solvent and a solution of (^{t}BuO)₃W≡CC(CH₃)₃ compound (3) in a second solvent to form a first reaction mixture;
(ii) warming the first reaction mixture to a second temperature in a range of about 0° C. to about 80° C.; and
(iii) removing at least a portion of the first solvent and the second solvent from the first reaction mixture to provide a second reaction mixture comprising compound (7);
(iv) admixing the second reaction mixture comprising compound (7) and a third solvent to form a third reaction mixture and cooling the third reacting mixture to a third temperature in a range of about −78° C. to about 0° C.;
(v) admixing the third reaction mixture and a base at the third temperature to form a fourth reaction mixture, wherein the base is optionally provided in solution with a fourth solvent;
(vi) warming the fourth reaction mixture to a fourth temperature in a range of about 0° C. to about 80° C. to form a fifth reaction mixture;
(vii) removing at least a portion of the third solvent from the fifth reaction mixture to provide a sixth reaction mixture;
(viii) washing the sixth reaction mixture with a fifth solvent and removing at least a portion of the fifth solvent to form a seventh reaction mixture;
(ix) admixing the seventh reaction mixture with a sixth solvent to provide the eighth reaction mixture;
(x) cooling the eighth reaction mixture to a fifth temperature in a range of about −78° C. to about 0° C. and admixing at the fifth temperature the eighth reaction mixture with a solution of methyl trifluoromethansulfonate (MeOTf) in a seventh solvent to form a ninth reaction mixture;
(xi) warming the ninth reaction mixture to a sixth temperature in a range of about 0° C. to about 80° C.; and
(xii) admixing a substituted alkyne and the ninth reaction mixture to form a tenth reaction mixture comprising the tetraanionic pincer ligand supported metallacycloalkylene complex (1), wherein compounds (7), (2), and (3) have the structures:

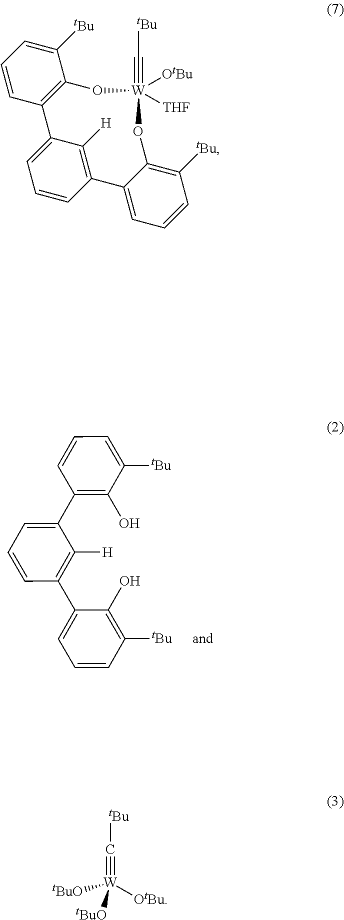

The methods of the disclosure can use prepared, isolated (7), such that the methods include steps (iv) to (xii).

The methods of the disclosure can further include:
(xiii) removing at least a portion of the solvents from the fifth reaction mixture to form a second solid mixture;
(xiv) re-suspending the solids of the second solid mixture in a fifth solvent and removing any insoluble solids by filtration to form the seventh reaction mixture;
(xv) adding a eighth solvent to the ninth reaction mixture after warming the ninth reaction mixture to the sixth temperature;
(xvi) removing at least a portion of the solvents from the tenth reaction mixture to form a third solid mixture;
(xvii) re-suspending the solids of the third solid mixture in a ninth solvent and removing any insoluble solids by filtration to form an eleventh reaction mixture; and/or
(xviii) removing the ninth solvent under reduced pressure to yield the tetraanionic pincer ligand supported metallacycloalkylene complex (1).

The methods of the disclosure can be carried out without isolating any intermediate compounds. In the methods of the disclosure, at least steps (iv) to (xii) are performed without isolating intermediate compounds. In the methods of the disclosure, at least steps (i) to (xii) are performed without isolating intermediate compounds. In the methods of the disclosure, at least steps (i) to (xviii) are performed without isolating intermediate compounds.

The disclosure further provides methods of preparing a trianionic pincer ligand supported metal-alkylidyne complex (5). The methods generally include:
(i) admixing at a first temperature in a range of about −78° C. to about 0° C. a solution of [^{t}BuOCO]H₃ compound (2) in a first solvent and a solution of (^{t}BuO)₃W≡CC(CH₃)₃ compound (3) in a second solvent to form a first reaction mixture;
(ii) warming the first reaction mixture to a second temperature in a range of about 0° C. to about 80° C.; and
(iii) removing at least a portion of the first solvent and the second solvent from the first reaction mixture to provide a second reaction mixture comprising compound (7);
(iv) admixing the second reaction mixture comprising compound (7) and a third solvent to form a third reaction mixture and cooling the third reacting mixture to a third temperature in a range of about −78° C. to about 0° C.;
(v) admixing the third reaction mixture and a base at the third temperature to form a fourth reaction mixture, wherein the base is optionally provided in solution with a fourth solvent;
(vi) warming the fourth reaction mixture to a fourth temperature in a range of about 0° C. to about 80° C. to form a fifth reaction mixture;
(vii) removing at least a portion of the third solvent from the fifth reaction mixture to provide a sixth reaction mixture;
(viii) washing the sixth reaction mixture with a fifth solvent and removing at least a portion of the fifth solvent to form a seventh reaction mixture;
(ix) admixing the seventh reaction mixture with a sixth solvent to provide the eighth reaction mixture;
(x) cooling the eighth reaction mixture to a fifth temperature in a range of about −78° C. to about 0° C. and admixing at the fifth temperature the eighth reaction mixture with a solution of methyl trifluoromethansulfonate (MeOTf) in a seventh solvent to form a ninth reaction mixture; and
(xi) warming the ninth reaction mixture to a sixth temperature in a range of about 0° C. to about 80° C. to form a twelfth reaction mixture comprising the trianionic pincer ligand supported metal-alkylidyne complex (5), wherein compound (7) and trianionic pincer ligand supported metal-alkylidyne complex (5) have the structures:

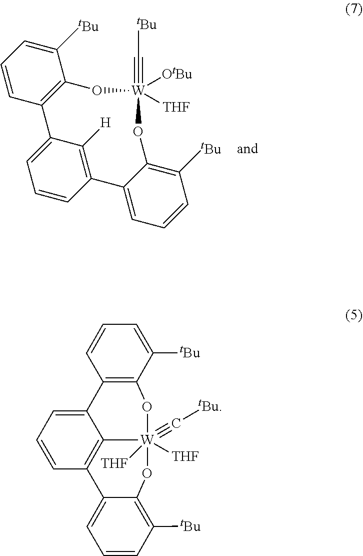

The methods of the disclosure can use prepared, isolated (7), such that the methods include steps (iv) to (xi).

The methods of the disclosure can further include:
(xix) removing at least a portion of the solvents from the fifth reaction mixture to form a second solid mixture;
(xx) re-suspending the solids of the second solid mixture in the fifth solvent and removing any insoluble solids by filtration to form the seventh reaction mixture;
(xxi) adding an eighth solvent to the ninth reaction mixture after warming the ninth reaction mixture to the sixth temperature;
(xxii) removing at least a portion of the solvents from the twelfth reaction mixture to form a fourth solid mixture;
(xxiii) re-suspending the solids of the third solid mixture in an eighth solvent and removing any insoluble solids by filtration to form a tenth reaction mixture; and/or
(xxiv) removing the eighth solvent under reduced pressure to yield the trianionic pincer ligand supported metal-alkylidyne complex (5).

In the methods of the disclosure, at least steps (iv) to (xi) are performed without isolating intermediate compounds. In the methods of the disclosure, at least steps (i) to (xi) are performed without isolating intermediate compounds. In the methods of the disclosure, at least steps (i) to (xi) and (xix) to (xxiv) are performed without isolating intermediate compounds.

The following disclosure applies to any methods disclosed herein.

The first, third, and fifth temperatures, independently, can generally be any temperature in a range of about −78° C. to about 0° C., for example, about −70° C. to about 0° C., about −60° C. to about −10° C., about −50° C. to about −20° C., about −40° C. to about −30° C., for example, about −35° C. In many cases, the third temperature is −35° C. In many cases, the first and fifth temperatures are each in a range of about −40° C. to about 0° C. In many cases, the third temperature is −35° C. and the first and fifth temperatures are each in a range of about −20° C. to about 0° C.

The term “about” is used according to its ordinary meaning, for example, to mean approximately or around. In one embodiment, the term “about” means [±10% of a stated value or range of values. In another embodiment, the term “about” means±5% of a stated value or range of values. A value or range described in combination with the term “about” expressly includes the specific value and/or range as well (e.g., for a value described as “about 40,” “40” is also expressly contemplated).

The second, fourth, and sixth temperatures, independently, can generally be any temperature in a range of about 0° C. to about 80° C., for example, in a range of about 0° C. to about 70° C., about 0° C. to about 60° C., about 0° C. to about 50° C., about 0° C. to about 40° C., about 10° C. to about 30° C., about 15° C. to about 25° C., or about 20° C. to about 24° C. In many cases, the second, fourth, and sixth temperatures, in a range of about 0° C. to about 25° C. In many cases, the second, fourth, and sixth temperatures, in a range of about 10° C. to about 24° C.

In general, compound (2) and compound (3) are admixed in a molar ratio in a range of 1:1 to 1:3, 1:1.05 to 1:3, 1:1.05 to 1:2, 1:1.05 to 1:1.5, 1:1.05 to 1:1.25, or 1:1.10 to 1:1.20. The admixing of compound (2) and compound (3) can include dropwise addition of the solution of compound (3) to the solution of compound (2). Generally, compound (3) is used in slight excess to ensure complete reaction of compound (2).

The first, second, third, fourth, sixth, seventh, and eighth solvents, individually, can be selected from the group of tetrahydrofuran (THF), ethyl ether (Et₂O), 2-methyltetrahydrofuran, 1,4-dioxane, hexanes, benzene, toluene, pentane, and a combination thereof.

The first solvent can be selected from the group of tetrahydrofuran (THF), ethyl ether (Et₂O), 2-methyltetrahydrofuran, 1,4-dioxane, and a combination thereof. The first solvent can include THF. The second solvent can be selected from the group of tetrahydrofuran (THF), ethyl ether (Et₂O), 2-methyltetrahydrofuran, 1,4-dioxane, and a combination thereof. The second solvent can include THF. The third solvent can be selected from the group of Et₂O, THF, 2-methyltetrahydrofuran, 1,4-dioxane, hexanes, benzene, toluene, pentane, and a combination thereof. The third solvent can include Et₂O. The fourth solvent can be selected from the group of Et₂O, THF, 2-methyltetrahydrofuran, 1,4-dioxane, hexanes, benzene, toluene, pentane, and a combination thereof. The fourth solvent can include Et₂O. The sixth solvent can be selected from the group of tetrahydrofuran (THF), ethyl ether (Et₂O), 2-methyltetrahydrofuran, 1,4-dioxane, and a combination thereof. The sixth solvent can include THF. The seventh solvent can be selected from the group of Et₂O, THF, 2-methyltetrahydrofuran, 1,4-dioxane, hexanes, benzene, toluene, pentane, and a combination thereof. The seventh solvent can include Et₂O. The eighth solvent can be selected from the group of Et₂O, THF, 2-methyltetrahydrofuran, 1,4-dioxane, hexanes, benzene, toluene, pentane, and a combination thereof. The eighth solvent can include Et₂O.

The fifth, ninth, and tenth solvents can be selected from the group of pentane, hexane, heptane, or a combination thereof. The seventh solvent can include pentane or hexane. The eighth solvent can be selected from the group of pentane, hexane, heptane, or a combination thereof. The eighth solvent can include pentane or hexane.

Warming the first reaction mixture to the second temperature, warming the fourth reaction mixture to the fourth temperature, or warming the ninth reaction mixture to the sixth temperature can, independently, include warming the reaction mixture with stirring for a time in a range of about 1 hour to about 48 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours. Warming the first reaction mixture to the second temperature can include warming the reaction mixture with stirring for a time in a range about 1 hour to about 2 hours. Warming the fourth reaction mixture to the fourth temperature can include warming the reaction mixture with stirring for a time in a range about 1 hour to about 2 hours. Warming the ninth reaction mixture to the sixth temperature can include warming the reaction mixture with stirring for a time in a range about 1 hour to about 2 hours.

Removing at least a portion of the first solvent and the second solvent can include removing the solvents under reduced pressure to form a first solid mixture. At least 50% by volume of the first solvent and the second solvent can be removed, based on the total volume of first and second solvent, for example, in a range of about 50% to about 100%, about 60% to about 99%, about 70% to about 95%, about 75% to about 90%, about 80% to about 85%, by volume, based on the total volume of the first and second solvents. Removing at least a portion of the first solvent and the second solvent can include triturating the first solid mixture with pentane to remove the ^{t}BuOH side product. The first solid mixture can be triturated with pentane one or more times, for example, twice, three times, or four times. The solid mixture can be triturated with pentane at least three times.

The base can generally be any non-nucleophilic base. The base can include a ylide, potassium bis(trimethylsilyl)amide (KN(TMS)₂), lithium tetramethylpiperidide, lithium diisopropylamide, potassium diisopropylamide, or a combination thereof. The base can include a ylide selected from the group of a phosphorus ylide, a sulfonium ylide, a sulfoxonium ylide, a carbonyl ylide, an oxonium ylide, an azomethine ylide, a nitrile ylide, and a combination thereof. The ylide can be selected from the group of a phosphorus ylide, a sulfonium ylide, a carbonyl ylide, an azomethine ylide, and a combination thereof. The ylide can be a phosphorus ylide. The ylide can be Ph₃P═CH₂.

Admixing the base and the third reaction mixture can include admixing the base in an amount of in a range of about 0.5 to about 2 molar equivalences, relative to the amount of compound (2) included in the step of admixing compound (2) and compound (3), for example, in a range of about 0.5 to about 1.5 molar equivalences, or about 1 molar equivalence. In many cases, the base is present in a range of about 1.0 to about 1.1 molar equivalences, relative to the amount of compound (2) included in the step of admixing compound (2) and compound (3).

Removing at least a portion of the third solvent can include removing the solvents under reduced pressure to form a second solid mixture. At least 50% by volume of the third solvent can be removed, based on the total volume of third solvent, for example, in a range of about 50% to about 100%, about 60% to about 99%, about 70% to about 95%, about 75% to about 90%, about 80% to about 85%, by volume, based on the total volume of the third solvent.

Admixing the MeOTf and the eighth reaction mixture can include admixing the MeOTf in an amount in a range of about 0.5 to about 2 molar equivalences, relative to the amount of compound (2) included in the step of admixing compound (2) and compound (3), for example, in a range of about 0.5 to about 1.5 molar equivalences, or about 1 molar equivalence. Admixing the MeOTf and the eighth reaction mixture can include dropwise addition of the solution of MeOTf with stirring. In many cases, the MeOTf is present in a range of about 1.0 to about 1.5 molar equivalences, relative to the amount of compound (2) included in the step of admixing compound (2) and compound (3).

Admixing the substituted alkyl to the ninth reaction mixture can be performed after the ninth reaction mixture has been at the sixth temperature for about 5 minutes to about 24 hours, about 5 minutes to about 18 hours, about 5 minutes to about 12 hours, about 5 minutes to about 6 hours, about 5 minutes to about 4 hours, about 5 minutes to about 2 hours, about 5 minutes to about 1 hour, about 5 minutes to about 45 minutes, about 5 minutes to about 30 minutes, or about 5 minutes to about 15 minutes. Admixing the substituted alkyl to the ninth reaction mixture can be performed after the ninth reaction mixture has been at the sixth temperature for time in a range of about 5 minutes to about 1 hour.

The substituted alkyne can generally be any substituted alkyne. The substituted alkyne can include a monosubstituted alkyne. The substituted alkyne can include phenylacetylene, trimethylsilylacetylene, 3,3-dimethyl-1-butyne, or a combination thereof. The substituted alkyne can include a disubstituted alkyne.

Admixing the substituted alkyne and the ninth reaction mixture can include admixing the substituted alkyne in an amount in a range of about 1 to about 50 molar equivalences, relative to the amount of compound (2) included in the step of admixing compound (2) and compound (3), for example, in a range of about 1 to about 40 molar equivalences, about 1 to about 30 molar equivalences, about 1 to about 25 molar equivalences, about 1 to about 20 molar equivalences, about 1 to about 10 molar equivalences, or about 1 to about 5 molar equivalences. Without intending to be bound by theory, it is believed that as the size of the alkyne increases, the likelihood of the alkyne to polymerize in the sixth reaction mixture at the sixth temperature decreases and the alkyne can be admixed at higher equivalences and/or faster rates. Further, without intending to be bound by theory, it is believed that as the size of the alkyne decreases, the likelihood of the alkyne to polymerize in the sixth reaction mixture at the sixth temperature decreases and the alkyne can be admixed at lower equivalences and/or slower rates. For example, the substituted alkyne can be in a range of about 5 to about 50 molar equivalences, relative to the amount of compound (2) included in the step of admixing compound (2) and compound (3) when the sixth temperature is in a range of about 0° C. to about 25° C., and in a range of about 1 to about 5 molar equivalences, relative to the amount of compound (2) included in the step of admixing compound (2) and compound (3) when the sixth temperature is in a range of about 25° C. to about 80° C. In many cases, the substituted alkyne can be in a range of about 5 to about 50 molar equivalences, relative to the amount of compound (2) included in the step of admixing compound (2) and compound (3) when the sixth temperature is in a range of about 0° C. to about 25° C.

Removing at least a portion of the solvents from the tenth reaction mixture can include removing the solvents under reduced pressure to form a third solid mixture. At least 50% by volume of the solvent can be removed, based on the total solvent in the tenth reaction mixture, for example, in a range of about 50% to about 100%, about 60% to about 99%, about 70% to about 95%, about 75% to about 90%, about 80% to about 85%, by volume, based on the total volume of the solvent in the tenth reaction mixture.

The ninth solvent can be removed from the eleventh reaction mixture under reduced pressure to yield the tetraanionic pincer ligand supported metallacycloalkylene complex (1).

The tetraanionic pincer ligand supported metallacycloalkylene complex can be selected from the group of:

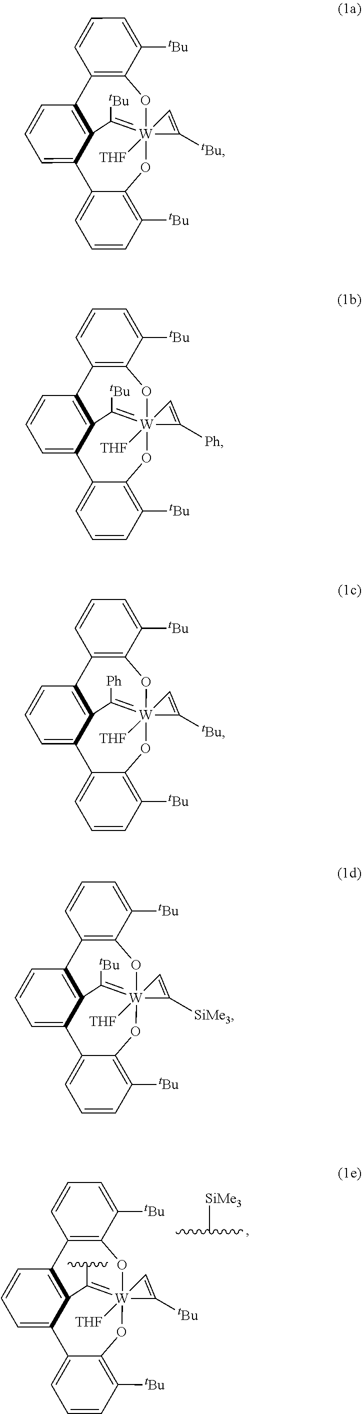

and a combination thereof. The tetraanionic pincer ligand supported metallacycloalkylene complex can be (1a). The tetraanionic pincer ligand supported metallacycloalkylene complex can be a combination of (1b) and (1c). The tetraanionic pincer ligand supported metallacycloalkylene complex can be a combination of (1d) and (1e).

Removing at least a portion of the solvents from the twelfth reaction mixture can include removing the solvents under reduced pressure to form a fourth solid mixture. At least 50% by volume of the solvent can be removed, based on the total solvent in the ninth reaction mixture, for example, in a range of about 50% to about 100%, about 60% to about 99%, about 70% to about 95%, about 75% to about 90%, about 80% to about 85%, by volume, based on the total volume of the solvent in the twelfth reaction mixture.

The tenth solvent can be removed from the thirteenth reaction mixture under reduced pressure to yield the trianionic pincer ligand supported metal-alkylidyne complex (5).

### Embodiments

1. A method of preparing a tetraanionic pincer ligand supported metallacycloalkylene complex (1), comprising:
admixing a second reaction mixture comprising compound (7) and a third solvent to form a third reaction mixture and cooling the third reacting mixture to a third temperature in a range of about −78° C. to about 0° C.;
admixing the third reaction mixture and a base at the third temperature to form a fourth reaction mixture;
warming the fourth reaction mixture to a fourth temperature in a range of about 0° C. to about 80° C. to form a fifth reaction mixture;
cooling the fifth reaction mixture to a fifth temperature in a range of about −78° C. to about 0° C. and admixing at the fifth temperature the fifth reaction mixture with a solution of methyl trifluoromethansulfonate (MeOTf) in a fifth solvent to form a sixth reaction mixture;
warming the sixth reaction mixture to a sixth temperature in a range of about 0° C. to about 80° C.; and
admixing a substituted alkyne and the sixth reaction mixture to form a seventh reaction mixture comprising the tetraanionic pincer ligand supported metallacycloalkylene complex (1), wherein compound (7) has the structure:

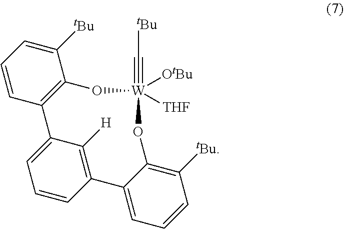

2. The method of embodiment 1, further comprising preparing the second reaction mixture comprising compound (7), by
admixing at a first temperature in a range of about −78° C. to about 0° C. a solution of [^{t}BuOCO]H₃ compound (2) in a first solvent and a solution of (^{t}BuO)₃W≡CC(CH₃)₃ compound (3) in a second solvent to form a first reaction mixture;
warming the first reaction mixture to a second temperature in a range of about 0° C. to about 80° C.; and
removing at least a portion of the first solvent and the second solvent from the first reaction mixture to provide the second reaction mixture comprising compound (7), wherein compounds (2), and (3) have the structures:

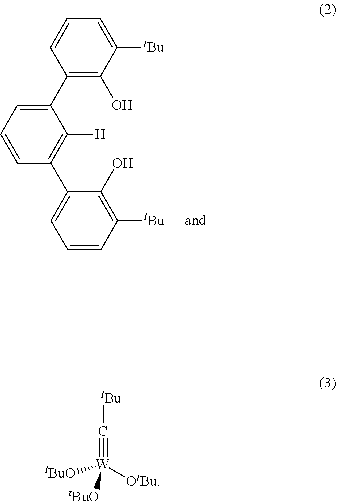

3. The method of embodiment 2, wherein compound (2) and compound (3) are admixed in a molar ratio in a range of 1:1 to 1:3, 1:1.05 to 1:3, 1:1.05 to 1:2, 1:1.05 to 1:1.5, 1:1.05 to 1:1.25, or 1:1.10 to 1:1.20.

4 The method of embodiment 2 or embodiment 3, wherein admixing of compound (2) and compound (3) comprises dropwise addition of the solution of compound (3) to the solution of compound (2).

5. The method of any one of embodiments 2 to 4, wherein the first solvent is selected from the group of tetrahydrofuran (THF), ethyl ether (Et₂O), 2-methyltetrahydrofuran, 1,4-dioxane, dichloromethane (DCM), hexanes, benzene, toluene, pentane, and a combination thereof.

6. The method of embodiment 4, wherein the second solvent is selected from the group of THF, Et₂O, 2-methyltetrahydrofuran, 1,4-dioxane, DCM, hexanes, benzene, toluene, pentane, and a combination thereof.

7 The method of any one of embodiments 2 to 6, wherein warming the first reaction mixture to the second temperature comprises warming the reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

8. The method of any one of embodiments 2 to 7, wherein removing at least a portion of the first solvent and the second solvent comprises removing the solvents under reduced pressure to form a solid mixture.

9. The method of embodiment 8, wherein removing at least a portion of the first solvent and the second solvent further comprises triturating the solid mixture with pentane one or more times, for example, twice, three times, or four times.

10. The method of any one of the preceding embodiments, wherein the third solvent comprises Et₂O, THF, 2-methyltetrahydrofuran, 1,4-dioxane, dichloromethane (DCM), hexanes, benzene, toluene, pentane, and a combination thereof.

11. The method of any one of the preceding embodiments, wherein the base comprises a ylide selected from the group of a phosphorus ylide, a sulfonium ylide, a sulfoxonium ylide, a carbonyl ylide, an oxonium ylide, an azomethine ylide, a nitrile ylide, or a combination thereof.

12. The method of any one of the preceding embodiments, wherein the base comprises Ph₃P═CH₂.

13. The method of any one of the preceding embodiments, wherein admixing the base comprises admixing the base in an amount of about 0.5 to about 2 molar equivalences, relative to the amount of compound (2) included in the step of admixing compound (2) and compound (3).

14. The method of any one of the preceding embodiments, wherein the base is provided in solution with a fourth solvent.

15. The method of embodiment 14, wherein the fourth solvent comprises Et₂O, THF, 2-methyltetrahydrofuran, 1,4-dioxane, dichloromethane (DCM), hexanes, benzene, toluene, pentane, and a combination thereof.

16. The method of any one of the preceding embodiments, wherein warming the fourth reaction mixture to the fourth temperature comprises warming the fourth reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

17. The method of any one of the preceding embodiments, wherein admixing the MeOTf comprises admixing MeOTf in an amount of about 0.5 to about 2 molar equivalences, relative to the amount of compound (2) included in the step of admixing compound (2) and compound (3).

18. The method of any one of the preceding embodiments, wherein fifth solvent comprises Et₂O, THF, 2-methyltetrahydrofuran, 1,4-dioxane, dichloromethane (DCM), hexanes, benzene, toluene, pentane, and a combination thereof.

19. The method any one of the preceding embodiments, wherein admixing the fifth reaction mixture with MeOTf comprises dropwise addition of the solution of MeOTf to the fifth reaction mixture, with stirring.

20. The method of any one of the preceding embodiments, wherein warming the sixth reaction mixture to the sixth temperature comprises warming the sixth reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

21. The method of any one of the preceding embodiments, further comprising adding a sixth solvent to the sixth reaction mixture after warming the sixth reaction mixture to the sixth temperature, wherein the solvent is selected from the group of THF, Et₂O, 2-methyltetrahydrofuran, 1,4-dioxane, DCM, hexanes, benzene, toluene, pentane, and a combination thereof.

22. The method of any one of the preceding embodiments, wherein admixing the substituted alkyne to the sixth reaction mixture is performed after the sixth reaction mixture has been at the sixth temperature for about 5 minutes to about 24 hours, about 5 minutes to about 18 hours, about 5 minutes to about 12 hours, about 5 minutes to about 6 hours, about 5 minutes to about 4 hours, about 5 minutes to about 2 hours, about 5 minutes to about 1 hour, about 5 minutes to about 45 minutes, about 5 minutes to about 30 minutes, or about 5 minutes to about 15 minutes.

23. The method of any one of the preceding embodiments, further comprising removing at least a portion of the solvents from the seventh reaction mixture to form a second solid mixture.

24. The method of any one of the preceding embodiments, wherein the substituted alkyne comprises phenylacetylene, trimethylsilylacetylene, 3,3-dimethyl-1-butyne, or a combination thereof.

25. The method of any one of embodiments 1 to 23, wherein the substituted alkyne comprises a disubstituted alkyne.

26. The method of any one of the preceding embodiments, wherein admixing the substituted alkyne and the sixth reaction mixture comprises admixing the substituted alkyne in an amount of about 1 to about 50 molar equivalences, relative to the amount of compound (2) included in the step of admixing compound (2) and compound (3).

27. The method of embodiment 23, wherein removing at least a portion of the solvents from the seventh reaction mixture comprises removing the solvents under reduced pressure.

28. The method of any one of embodiments 23 to 27, further comprising re-suspending the solids of the second solid mixture in a seventh solvent comprising pentane, heptane, octane, nonane, decane, or a combination thereof, and removing any insoluble solids by filtration to form an eighth reaction mixture.

29. The method of embodiment 28, further comprising removing the seventh solvent under reduced pressure to yield the tetraanionic pincer ligand supported metallacycloalkylene complex (1).

30. The method of any one of the preceding embodiments, wherein the tetraanionic pincer ligand supported metallacycloalkylene complex is selected from the group of:

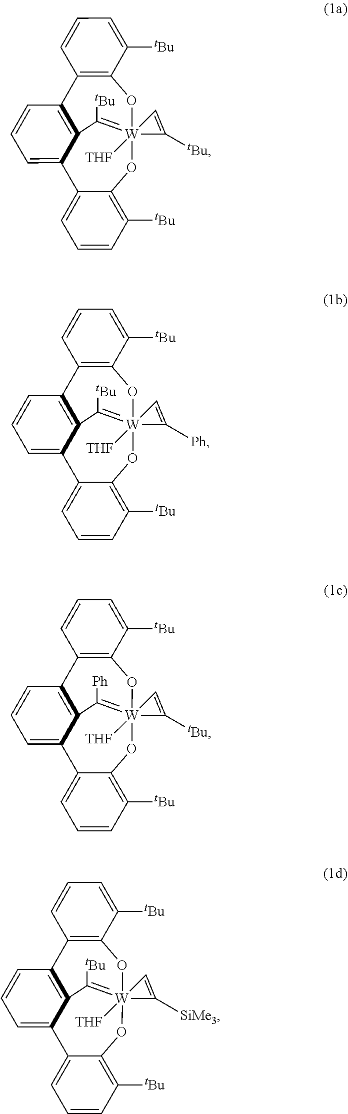

and a combination thereof.

31. A method of preparing a trianionic pincer ligand supported metal-alkylidyne complex (5), comprising:
admixing a second reaction mixture comprising compound (7) and a third solvent to form a third reaction mixture and cooling the third reacting mixture to a third temperature in a range of about −78° C. to about 0° C.;
admixing the third reaction mixture and an base at the third temperature to form a fourth reaction mixture;
warming the fourth reaction mixture to a fourth temperature in a range of about 0° C. to about 80° C. to form a fifth reaction mixture;
cooling the fifth reaction mixture to a fifth temperature in a range of about −78° C. to about 0° C. and admixing at the fifth temperature the fifth reaction mixture with a solution of methyl trifluoromethansulfonate (MeOTf) in a fifth solvent to form a sixth reaction mixture; and
warming the sixth reaction mixture to a sixth temperature in a range of about 0° C. to about 80° C.
to form a ninth reaction mixture comprising the trianionic pincer ligand supported metal-alkylidyne complex (5), wherein compound (7) and trianionic pincer ligand supported metal-alkylidyne complex (5) have the structures:

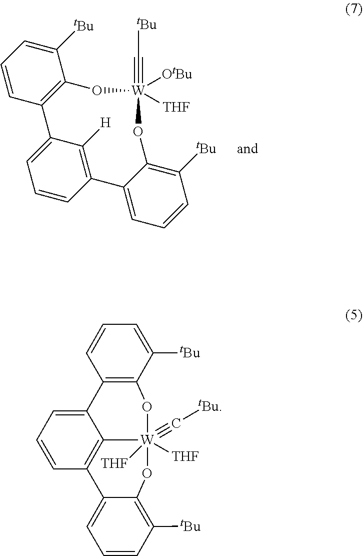

32. The method of embodiment 31, further comprising preparing the second reaction mixture comprising compound (7), by
admixing at a first temperature in a range of about −78° C. to about 0° C. a solution of [^{t}BuOCO]H₃ compound (2) in a first solvent and a solution of (^{t}BuO)₃W≡CC(CH₃)₃ compound (3) in a second solvent to form a first reaction mixture;
warming the first reaction mixture to a second temperature in a range of about 0° C. to about 80° C.; and
removing at least a portion of the first solvent and the second solvent from the first reaction mixture to provide the second reaction mixture comprising compound (7), wherein compounds (2), and (3) have the structures:

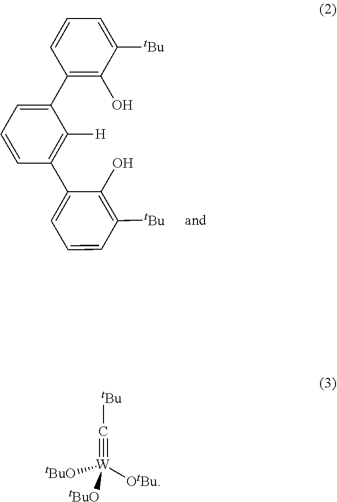

33. The method of embodiment 32, wherein compound (2) and compound (3) are admixed in a molar ratio in a range of 1:1 to 1:3, 1:1.05 to 1:3, 1:1.05 to 1:2, 1:1.05 to 1:1.5, 1:1.05 to 1:1.25, or 1:1.10 to 1:1.20.

34. The method of embodiment 32 or embodiment 33, wherein admixing of compound (2) and compound (3) comprises dropwise addition of the solution of compound (3) to the solution of compound (2).

35. The method of any one of embodiments 32 to 34, wherein the first solvent is selected from the group of tetrahydrofuran (THF), ethyl ether (Et₂O), 2-methyltetrahydrofuran, 1,4-dioxane, dichloromethane (DCM), hexanes, benzene, toluene, pentane, and a combination thereof.

36. The method of embodiment 34, wherein the second solvent is selected from the group of THF, Et₂O, 2-methyltetrahydrofuran, 1,4-dioxane, DCM, hexanes, benzene, toluene, pentane, and a combination thereof.

37. The method of any one of embodiments 32 to 36, wherein warming the first reaction mixture to the second temperature comprises warming the reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

38. The method of any one of embodiments 32 to 37, wherein removing at least a portion of the first solvent and the second solvent comprises removing the solvents under reduced pressure to form a solid mixture.

39. The method of embodiment 38, wherein removing at least a portion of the first solvent and the second solvent further comprises triturating the solid mixture with pentane one or more times, for example, twice, three times, or four times.

40. The method of any one of embodiments 31 to 39, wherein the third solvent comprises Et₂O, THF, 2-methyltetrahydrofuran, 1,4-dioxane, dichloromethane (DCM), hexanes, benzene, toluene, pentane, and a combination thereof.

41. The method of any one of embodiments 31 to 40, wherein the base comprises a ylide selected from the group of a phosphorus ylide, a sulfonium ylide, a sulfoxonium ylide, a carbonyl ylide, an oxonium ylide, an azomethine ylide, a nitrile ylide, or a combination thereof.

42. The method of any one of embodiments 31 to 41, wherein the base comprises Ph₃P═CH₂,

43. The method of any one of embodiments 31 to 42, wherein admixing the base comprises admixing the base in an amount of about 0.5 to about 2 molar equivalences, relative to the amount of compound (2) included in the step of admixing compound (2) and compound (3).

44. The method of any one of embodiments 31 to 43, wherein the base is provided in solution with a fourth solvent.

45. The method of embodiment 44, wherein the fourth solvent comprises Et₂O, THF, 2-methyltetrahydrofuran, 1,4-dioxane, dichloromethane (DCM), hexanes, benzene, toluene, pentane, and a combination thereof.

46. The method of any one of embodiments 31 to 45, wherein warming the fourth reaction mixture to the fourth temperature comprises warming the fourth reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

47. The method of any one of the embodiments 31 to 46, wherein admixing the MeOTf and the fifth reaction mixture comprises admixing MeOTf in an amount of about 0.5 to about 2 molar equivalences, relative to the amount of compound (2) included in the step of admixing compound (2) and compound (3).

48. The method of any one of embodiments 31 to 47, wherein fifth solvent comprises Et₂O, THF, 2-methyltetrahydrofuran, 1,4-dioxane, dichloromethane (DCM), hexanes, benzene, toluene, pentane, and a combination thereof.

49. The method any one of embodiments 31 to 48, wherein admixing the fifth reaction mixture with MeOTf comprises dropwise addition of the solution MeOTf to the fifth reaction mixture, with stirring.

50. The method of any one of embodiments 31 to 49, wherein warming the sixth reaction mixture to the sixth temperature comprises warming the sixth reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

51. The method of any one of embodiments 31 to 50, further comprising adding a sixth solvent to the sixth reaction mixture after warming the sixth reaction mixture to the sixth temperature, wherein the solvent is selected from the group of THF, Et₂O, 2-methyltetrahydrofuran, 1,4-dioxane, DCM, hexanes, benzene, toluene, pentane, and a combination thereof.

52. The method of any one of embodiments 31 to 51, further comprising removing at least a portion of the solvents from the ninth reaction mixture to form a third solid mixture.

53. The method of embodiment 52, wherein removing at least a portion of the solvents from the ninth reaction mixture comprises removing the solvents under reduced pressure.

54. The method of embodiment 52 or 53, further comprising re-suspending the solids of the third solid mixture in an eighth solvent comprising pentane, heptane, octane, nonane, decane, or a combination thereof, and removing any insoluble solids by filtration to form a tenth reaction mixture.

55. The method of embodiment 54, further comprising removing the eighth solvent under reduced pressure to yield trianionic pincer ligand supported metal-alkylidyne complex (5).

The above-described aspects and embodiments can be better understood in light of the following examples, which are merely intended to be illustrative and are not meant to limit the scope in any way.

### Examples

Unless specified otherwise, all manipulations were performed under an inert atmosphere using glove-box techniques. Pentane was dried using a GlassCountour drying column. 3,3-dimethyl-1-buttyne was purchased from Sigma-Aldrich, and distilled from calcium hydride, degassed by freeze pump thawing, and stored over molecular sieves prior to use. [^{t}BuOCO]H₃ (2) was prepared according to literature procedure, as described in Organometallics 2023, 42, 12, 1339-1346. NMR spectra were obtained on Varian INOVA 500 MHz and Varian INOVA2 500 MHz spectrometers or equivalent. Chemical shifts are reported in & (ppm). For ¹H and ¹³C NMR spectra, the residual solvent peaks were used as an internal reference.

### Synthesis of [O₂C(^{t}BuC═)W(η²—HC≡^{t}Bu)](1a)

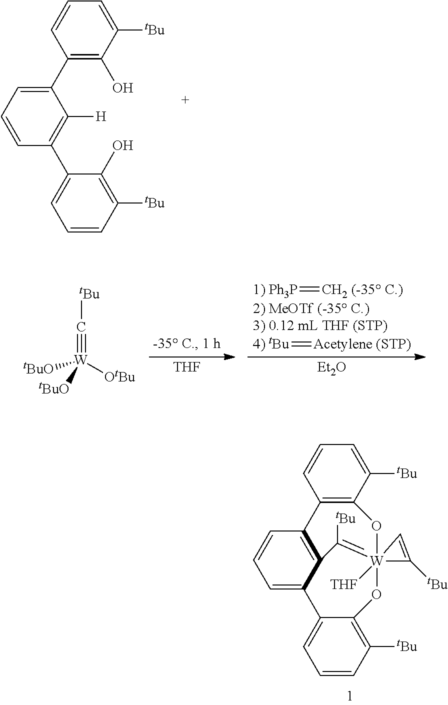

In a nitrogen filled glovebox a glass vial was charged with [^{t}BuOCO]H₃ (2)(48.8 mg, 0.130 mmol), 0.4 mL THF, and a stir bar. This mixture was cooled to −35° C. (^{t}BuO)₃W≡CC(CH₃)₃ (3)(72.1 mg, 0.152 mmol) was dissolved in 0.4 mL of THF. The solution of (^{t}BuO)₃W≡CC(CH₃)₃ was added dropwise to the cooled solution with vigorous stirring. The reaction was allowed to warm to room temperature with stirring over 1 h. Volatiles were removed under reduced pressure and the resulting solids were triturated with pentane (1 mL×3) to ensure complete removal of the ^{t}BuOH byproduct. Et₂O (0.5 mL) was added to the vial and the solution was cooled to −35° C. A solution of Ph₃P═CH₂ (37.1 mg, 0.130 mmol) in 0.5 mL Et₂O was added in one shot to the cooled reaction mixture. The vial containing Ph₃P═CH₂ was rinsed with an additional 0.5 mL Et₂O which was added to the reaction mixture to ensure full transfer of Ph₃P═CH₂. The reaction mixture was allowed to warm to room temperature with stirring over 1 h during which time it changed from a homogenous orange solution to a heterogenous yellow mixture. The reaction mixture was again cooled to −35° C. Then, a solution of MeOTf (14.7 μL, 0.130 mmol) in 0.5 mL Et₂O was added dropwise to the stirring reaction mixture. The reaction was allowed to warm to room temperature over 1 h during which time the solution turned orange and then a deep red. Next, 0.112 mL THF was added to the solution. After 5 min 3,3, -dimethyl-1-butyne (80.2 μL, 0.651 mmol) was added in one shot via micropipette with stirring. After 5 min the solution turned light yellow and volatiles were removed under reduced pressure. The solids were redissolved in pentane (2×1 mL) and insoluble solids were removed by filtration. Removing pentane under reduced pressure yielded 1a in quantitative yield.

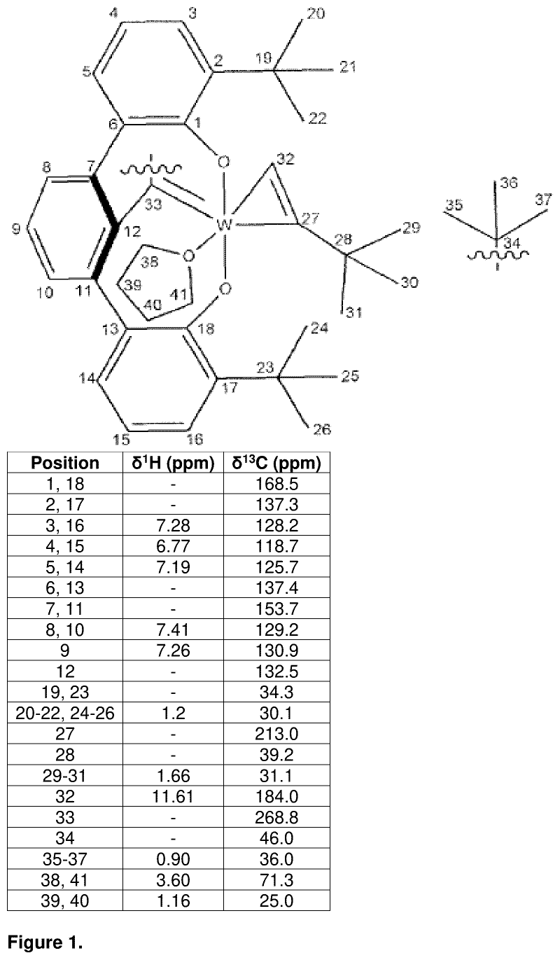

¹H NMR (500 MHZ, C₇D₈, δ (ppm)): 11.61 (s, 1H, W—CH₃₂), 7.41 (d, 2H, Ar—H_{8,10}), 7.28 (dd, 2H, Ar—H_{3,16}), 7.26 (t, 1H, Ar—Hg), 7.19 (dd, 2H, Ar—H_{5,14}), 6.77 (t, 2H, Ar—H_{4,15}), 3.60 (t, 4H, THF-H_{38,41}), 1.66 (s, 9H, W—C—C(CH₃)₃ (H₂₉-31)), 1.20 (s, 18H, ligand C(CH₃)₃ (H_{20-22,24-26})), 1.16 (t, 4H, THF-H_{39,40}), 0.90 (s, 9H, W═C(CH₃)₃ (H₃₅₋₃₇)). ¹³C NMR: 268.8 (s, W≡CC(CH₃)₃ (C₃₃)), 213.0 (s, WCCC(CH₃)₃ (C₂₇)), 184.0 (s, WCCC(CH₃)₃ (C₃₂)), 168.5 (s, C_{1,18}), 153.7 (s, Ar—C_{7,11}). 137.4 (s, Ar—C_{6,13}), 137.3 (s, Ar—C_{2,17}), 132.5 (s, Ar—C₁₂), 130.9 (s, Ar-Cg), 129.2 (s, Ar—C_{8,10}), 128.2 (s, Ar—C_{3,16}), 125.7 (s, Ar—C_{5,14}), 118.7 (s, Ar—C_{4,15}), 71.3 (s, THF-C_{38,41}), 46.0 (s, W≡CC(CH₃)₃ (C₃₄)), 39.2 (s, WCCC(CH₃)₃ (C₂₈)), 36.0 (s, W≡CC(CH₃)₃ (C₃₅₋₃₇)), 34.3 (s, ligand C(CH₃)₃ (C_{19,23})), 31.1 (s, WCCC(CH₃)₃ (C₂₉₋₃₁)), 30.1 (s, ligand C(CH₃)₃ (C_{20-22,24-26})), 25.00 (s, THF C_{39,40}). FIG. 1 provides ¹H, and ¹³C NMR signals for complex (1a).

### Alternative Synthesis of [O₂C (^{t}BuC═)W(η²—HC≡^{t}Bu)](1a)

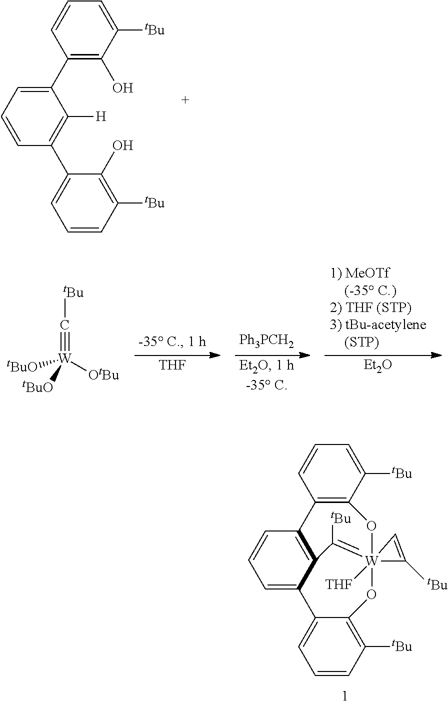

In a nitrogen filled glovebox a glass vial was charged with [^{t}BuOCO]H₃ (2)(48.8 mg, 0.130 mmol), 0.4 mL THF, and a stir bar. This mixture was cooled to −35° C. (^{t}BuO)₃W≡CC(CH₃)₃ (3)(72.1 mg, 0.152 mmol) was dissolved in 0.4 mL of THF. The solution of (^{t}BuO)₃W≡CC(CH₃)₃ was added dropwise to the cooled solution with vigorous stirring. The reaction was allowed to warm to room temperature with stirring over 1 h. Volatiles were removed under reduced pressure and the resulting solids were triturated with pentane (1 mL×3) to ensure complete removal of the ^{t}BuOH byproduct. Et₂O (1.0 mL) was added to the vial and the solution was cooled to −35° C. Solid Ph₃P═CH₂ (37.1 mg, 0.130 mmol) was added to the cooled reaction mixture. The vial containing Ph₃P═CH₂ was rinsed with an additional 0.5 mL Et₂O which was added to the reaction mixture to ensure full transfer of Ph₃P═CH₂. The reaction mixture was allowed to warm to room temperature with stirring over 1 h during which time it changed from a homogenous yellow/orange solution to a heterogenous yellow mixture. Volatiles were removed under vacuum and the resulting mixture was washed with pentane (1 mL×3) to obtain a bright yellow precipitate. The bright yellow precipitate was suspended in Et₂O (1 mL) and the reaction mixture was again cooled to −35° C. Then, a solution of MeOTf (14.7 μL, 0.130 mmol) in 0.5 mL Et₂O was added dropwise to the stirring reaction mixture. The reaction was allowed to warm to room temperature over 1 h during which time the solution turned orange and then a deep red. Next, 0.112 mL THF was added to the solution. After 5 min 3,3, -dimethyl-1-butyne (80.2 μL, 0.651 mmol) was added in one shot via micropipette with stirring. After 5 min the solution turned light yellow, and volatiles were removed under reduced pressure. The solids were redissolved in pentane (2×1 mL) and insoluble solids were removed by filtration. Removing pentane under reduced pressure yielded 1a in quantitative yield.

### Synthesis of (7)

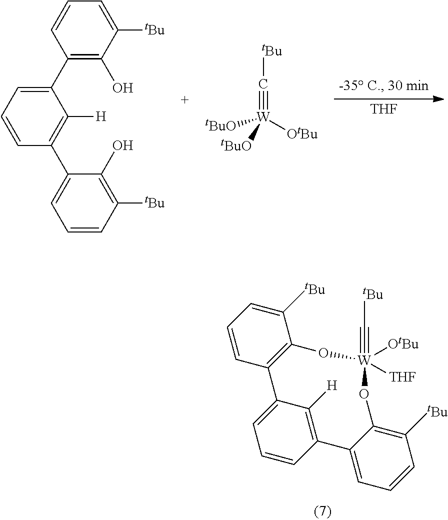

In a nitrogen filled glove box, a glass vial was charged with [^{t}BuOCO]H₃ (2)(140 mg, 0.37 mmol) in THF (1 mL) and cooled to −35° C. In another vial, (^{t}BuO)₃W≡CC(CH₃)₃ (3) (200 mg, 0.42 mmol) was dissolved in THF (1 mL) and added dropwise to the first solution while stirring. As the solution warmed to room temperature a gradual color change from brown to dark yellow was observed, and the stirring was continued for 30 min at room temperature. A dark yellow tacky material was obtained after removing all volatiles. As cold pentane (4 mL) was added, a bright yellow material (7) precipitated from a brown suspension. Product was filtered immediately and washed with additional cold pentane.

### Synthesis of (1a) from isolated (7)

In a nitrogen filled glove box, a glass vial is charged with compound (7)(0.130 mmol) and Et₂O (0.5 mL) and the solution is cooled to −35° C. A solution of Ph₃P═CH₂ (37.1 mg, 0.130 mmol) in 0.5 mL Et₂O is added in one shot to the cooled reaction mixture. The vial containing Ph₃P═CH₂ is rinsed with an additional 0.5 mL Et₂O which is added to the reaction mixture to ensure full transfer of Ph₃P═CH₂. The reaction mixture is allowed to warm to room temperature with stirring over 1 h during which time it changes from a homogenous orange solution to a heterogenous yellow mixture. The reaction mixture is again cooled to −35° C. Then, a solution of MeOTf (14.7 μL, 0.130 mmol) in 0.5 mL Et₂O is added dropwise to the stirring reaction mixture. The reaction is allowed to warm to room temperature over 1 h during which time the solution turns orange and then a deep red. Next, 0.112 mL THF is added to the solution. After 5 min 3,3, -dimethyl-1-butyne (80.2 μL, 0.651 mmol) is added in one shot via micropipette with stirring. After 5 min the solution turns light yellow and volatiles are removed under reduced pressure. The solids are redissolved in pentane (2×1 mL) and insoluble solids are removed by filtration. Removing pentane under reduced pressure yields (1a) in quantitative yield.

### Synthesis of (1b) and (1c)

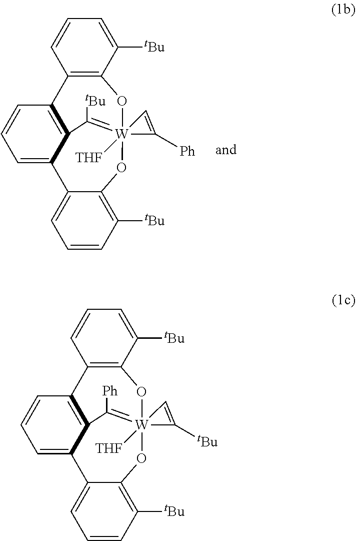

In a nitrogen filled glovebox a glass vial is charged with [^{t}BuOCO]H₃ (2)(48.8 mg, 0.130 mmol), 0.4 mL THF, and a stir bar. This mixture is cooled to −35° C. (^{t}BuO)₃W≡CC(CH₃)₃ (3)(72.1 mg, 0.152 mmol) is dissolved in 0.4 mL of THF. The solution of (^{t}BuO)₃W≡CC(CH₃)₃ is added dropwise to the cooled solution with vigorous stirring. The reaction is allowed to warm to room temperature with stirring over 1 h. Volatiles are removed under reduced pressure and the resulting solids are triturated with pentane (1 mL×3) to ensure complete removal of the ^{t}BuOH byproduct. Et₂O (0.5 mL) is added to the vial and the solution is cooled to −35° C. A solution of Ph₃P═CH₂ (37.1 mg, 0.130 mmol) in 0.5 mL Et₂O is added in one shot to the cooled reaction mixture. The vial containing Ph₃P═CH₂ is rinsed with an additional 0.5 mL Et₂O which is added to the reaction mixture to ensure full transfer of Ph₃P═CH₂. The reaction mixture is allowed to warm to room temperature with stirring over 1 h during which time it changes from a homogenous orange solution to a heterogenous yellow mixture. The reaction mixture is again cooled to −35° C. Then, a solution of MeOTf (14.7 μL, 0.130 mmol) in 0.5 mL Et₂O is added dropwise to the stirring reaction mixture. The reaction is allowed to warm to room temperature over 1 h during which time the solution turns orange and then a deep red. Next, 0.112 mL THF is added to the solution. After 5 min phenyl acetylene (0.651 mmol) is added in one shot via micropipette with stirring. After 5 min the solution turned yellow orange and volatiles were removed under reduced pressure. The solids are redissolved in pentane (2×1 mL) and insoluble solids are removed by filtration. Removing pentane under reduced pressure yields (1b) and (1c).

### Synthesis of (1d)

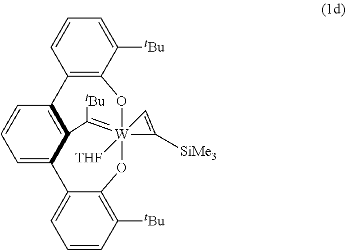

In a nitrogen filled glovebox a glass vial is charged with [^{t}BuOCO]H₃ (2)(48.8 mg, 0.130 mmol), 0.4 mL THF, and a stir bar. This mixture is cooled to −35° C.

(^{t}BuO)₃W≡CC(CH₃)₃ (3)(72.1 mg, 0.152 mmol) is dissolved in 0.4 mL of THF. The solution of (^{t}BuO)₃W≡CC(CH₃)₃ is added dropwise to the cooled solution with vigorous stirring. The reaction is allowed to warm to room temperature with stirring over 1 h. Volatiles are removed under reduced pressure and the resulting solids are triturated with pentane (1 mL×3) to ensure complete removal of the ^{t}BuOH byproduct. Et₂O (0.5 mL) is added to the vial and the solution is cooled to −35° C. A solution of Ph₃P═CH₂ (37.1 mg, 0.130 mmol) in 0.5 mL Et₂O is added in one shot to the cooled reaction mixture. The vial containing Ph₃P═CH₂ is rinsed with an additional 0.5 mL Et₂O which is added to the reaction mixture to ensure full transfer of Ph₃P═CH₂. The reaction mixture is allowed to warm to room temperature with stirring over 1 h during which time it changes from a homogenous orange solution to a heterogenous yellow mixture. The reaction mixture is again cooled to −35° C. Then, a solution of MeOTf (14.7 μL, 0.130 mmol) in 0.5 mL Et₂O is added dropwise to the stirring reaction mixture. The reaction is allowed to warm to room temperature over 1 h during which time the solution turns orange and then a deep red. Next, 0.112 mL THF is added to the solution. After 5 min trimethylsilylacetylene (0.651 mmol) is added in one shot via micropipette with stirring. After 5 min the solution turned light yellow and volatiles were removed under reduced pressure. The solids are redissolved in pentane (2×1 mL) and insoluble solids are removed by filtration. Removing pentane under reduced pressure yields (1d) and (1e).

### Preparation of Trianionic Pincer Ligand Supported Metal-Alkylidyne Complex (5)

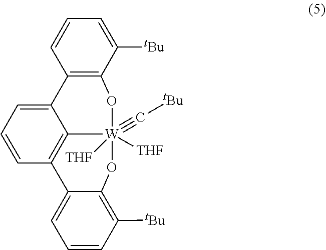

In a nitrogen filled glovebox a glass vial is charged with [^{t}BuOCO]H₃ (2)(48.8 mg, 0.130 mmol), 0.4 mL THF, and a stir bar. This mixture is cooled to −35° C. (^{t}BuO)₃W≡CC(CH₃)₃ (3)(72.1 mg, 0.152 mmol) is dissolved in 0.4 mL of THF. The solution of (^{t}BuO)₃W≡CC(CH₃)₃ is added dropwise to the cooled solution with vigorous stirring. The reaction is allowed to warm to room temperature with stirring over 1 h. Volatiles are removed under reduced pressure and the resulting solids are triturated with pentane (1 mL×3) to ensure complete removal of the ^{t}BuOH byproduct. Et₂O (0.5 mL) is added to the vial and the solution is cooled to −35° C. A solution of Ph₃P═CH₂ (37.1 mg, 0.130 mmol) in 0.5 mL Et₂O is added in one shot to the cooled reaction mixture. The vial containing Ph₃P═CH₂ is rinsed with an additional 0.5 mL Et₂O which is added to the reaction mixture to ensure full transfer of Ph₃P═CH₂. The reaction mixture is allowed to warm to room temperature with stirring over 1 h during which time it changes from a homogenous orange solution to a heterogenous yellow mixture. The reaction mixture is again cooled to −35° C. Then, a solution of MeOTf (14.7 μL, 0.130 mmol) in 0.5 mL Et₂O is added dropwise to the stirring reaction mixture. The reaction is allowed to warm to room temperature over 1 h during which time the solution turns orange and then a deep red. Volatiles are removed under reduced pressure. The solids are redissolved in pentane (2×1 mL) and insoluble solids are removed by filtration. Removing pentane under reduced pressure yielded (5).

The foregoing description is given for clearness of understanding only, and no unnecessary limitations should be understood therefrom, as modifications within the scope of the invention may be apparent to those having ordinary skill in the art.

All patents, publications and references cited herein are hereby fully incorporated by reference. In case of conflict between the present disclosure and incorporated patents, publications and references, the present disclosure should control.

What is claimed is:

1. A method of preparing a tetraanionic pincer ligand supported metallacycloalkylene complex (1), comprising:
admixing a second reaction mixture comprising compound (7) and a third solvent to form a third reaction mixture and cooling the third reacting mixture to a third temperature in a range of about −78° C. to about 0° C.;
admixing the third reaction mixture and a base at the third temperature to form a fourth reaction mixture;
warming the fourth reaction mixture to a fourth temperature in a range of about 0° C. to about 80° C. to form a fifth reaction mixture;
removing at least a portion of the third solvent from the fifth reaction mixture to provide a sixth reaction mixture;
washing the sixth reaction mixture with a fifth solvent and removing at least a portion of the fifth solvent to form a seventh reaction mixture;
admixing the seventh reaction mixture with a sixth solvent to provide the eighth reaction mixture;
cooling the eighth reaction mixture to a fifth temperature in a range of about −78° C. to about 0° C. and admixing at the fifth temperature the eighth reaction mixture with a solution of methyl trifluoromethansulfonate (MeOTf) in a seventh solvent to form a ninth reaction mixture;
warming the ninth reaction mixture to a sixth temperature in a range of about 0° C. to about 80° C.; and
admixing a substituted alkyne and the ninth reaction mixture to form a tenth reaction mixture comprising the tetraanionic pincer ligand supported metallacycloalkylene complex (1), wherein compound (7) has the structure:

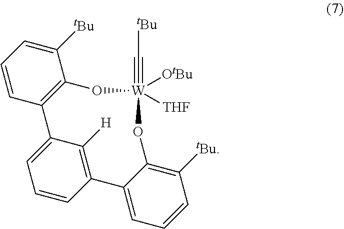

2. The method of claim 1, further comprising preparing the second reaction mixture comprising compound (7), by
admixing at a first temperature in a range of about −78° C. to about 0° C. a solution of [^{t}BuOCO]H₃ compound (2) in a first solvent and a solution of (^{t}BuO)₃W≡CC(CH₃)₃ compound (3) in a second solvent to form a first reaction mixture;
warming the first reaction mixture to a second temperature in a range of about 0° C. to about 80° C.; and
removing at least a portion of the first solvent and the second solvent from the first reaction mixture to provide the second reaction mixture comprising compound (7), wherein compounds (2), and (3) have the structures:

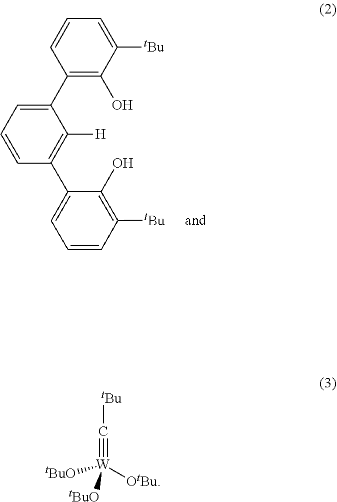

3. The method of claim 2, wherein compound (2) and compound (3) are admixed in a molar ratio in a range of 1:1 to 1:3, 1:1.05 to 1:3, 1:1.05 to 1:2, 1:1.05 to 1:1.5, 1:1.05 to 1:1.25, or 1:1.10 to 1:1.20.

4. The method of claim 2 or claim 3, wherein admixing of compound (2) and compound (3) comprises dropwise addition of the solution of compound (3) to the solution of compound (2).

5. The method of any one of claims 2 to 4, wherein the first solvent is selected from the group of tetrahydrofuran (THF), ethyl ether (Et₂O), 2-methyltetrahydrofuran, 1,4-dioxane, hexanes, benzene, toluene, pentane, and a combination thereof.

6. The method of claim 4, wherein the second solvent is selected from the group of THF, Et₂O, 2-methyltetrahydrofuran, 1,4-dioxane, hexanes, benzene, toluene, pentane, and a combination thereof.

7. The method of any one of claims 2 to 6, wherein warming the first reaction mixture to the second temperature comprises warming the reaction mixture with stirring for a time in a range of about 1 hour to about 48 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

8. The method of any one of claims 2 to 7, wherein removing at least a portion of the first solvent and the second solvent comprises removing the solvents under reduced pressure to form a first solid mixture.

9. The method of claim 8, wherein removing at least a portion of the first solvent and the second solvent further comprises triturating the first solid mixture with pentane one or more times, for example, twice, three times, or four times.

10. The method of any one of the preceding claims, wherein the third solvent comprises Et₂O, THF, 2-methyltetrahydrofuran, 1,4-dioxane, hexanes, benzene, toluene, pentane, and a combination thereof.

11. The method of any one of the preceding claims, wherein the base comprises a ylide selected from the group of a phosphorus ylide, a sulfonium ylide, a sulfoxonium ylide, a carbonyl ylide, an oxonium ylide, an azomethine ylide, a nitrile ylide, or a combination thereof.

12. The method of any one of the preceding claims, wherein the base comprises Ph₃P═CH₂.

13. The method of any one of the preceding claims, wherein admixing the base comprises admixing the base in an amount of about 0.5 to about 2 molar equivalences, relative to the amount of compound (2) included in the step of admixing compound (2) and compound (3).

14. The method of any one of the preceding claims, wherein the base is provided in solution with a fourth solvent.

15. The method of claim 14, wherein the fourth solvent comprises Et₂O, THF, 2-methyltetrahydrofuran, 1,4-dioxane, hexanes, benzene, toluene, pentane, and a combination thereof.

16. The method of any one of the preceding claims, wherein warming the fourth reaction mixture to the fourth temperature comprises warming the fourth reaction mixture with stirring for a time in a range of about 1 hour to about 48 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

17. The method of any one of the preceding claims, wherein admixing the MeOTf comprises admixing MeOTf in an amount of about 0.5 to about 2 molar equivalences, relative to the amount of compound (2) included in the step of admixing compound (2) and compound (3).

18. The method of any one of the preceding claims, wherein seventh solvent comprises Et₂O, THF, 2-methyltetrahydrofuran, 1,4-dioxane, hexanes, benzene, toluene, pentane, and a combination thereof.

19. The method any one of the preceding claims, wherein admixing the eighth reaction mixture with MeOTf comprises dropwise addition of the solution of MeOTf to the eighth reaction mixture, with stirring.

20. The method of any one of the preceding claims, wherein warming the ninth reaction mixture to the sixth temperature comprises warming the ninth reaction mixture with stirring for a time in a range of about 1 hour to about 48 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

21. The method of any one of the preceding claims, further comprising adding an eighth solvent to the ninth reaction mixture after warming the ninth reaction mixture to the sixth temperature, wherein the solvent is selected from the group of THF, Et₂O, 2-methyltetrahydrofuran, 1,4-dioxane, hexanes, benzene, toluene, pentane, and a combination thereof.

22. The method of any one of the preceding claims, wherein admixing the substituted alkyne to the ninth reaction mixture is performed after the ninth reaction mixture has been at the sixth temperature for about 5 minutes to about 48 hours, about 5 minutes to about 24 hours, about 5 minutes to about 18 hours, about 5 minutes to about 12 hours, about 5 minutes to about 6 hours, about 5 minutes to about 4 hours, about 5 minutes to about 2 hours, about 5 minutes to about 1 hour, about 5 minutes to about 45 minutes, about 5 minutes to about 30 minutes, or about 5 minutes to about 15 minutes.

23. The method of any one of the preceding claims, further comprising removing at least a portion of the solvents from the tenth reaction mixture to form a third solid mixture.

24. The method of any one of the preceding claims, wherein the substituted alkyne comprises phenylacetylene, trimethylsilylacetylene, 3,3-dimethyl-1-butyne, or a combination thereof.

25. The method of any one of claims 1 to 23, wherein the substituted alkyne comprises a disubstituted alkyne.

26. The method of any one of the preceding claims, wherein admixing the substituted alkyne and the ninth reaction mixture comprises admixing the substituted alkyne in an amount of about 1 to about 50 molar equivalences, relative to the amount of compound (2) included in the step of admixing compound (2) and compound (3).

27. The method of claim 23, wherein removing at least a portion of the solvents from the tenth reaction mixture comprises removing the solvents under reduced pressure.

28. The method of any one of claims 23 to 27, further comprising re-suspending the solids of the third solid mixture in a ninth solvent comprising pentane, hexane, or a combination thereof, and removing any insoluble solids by filtration to form an eleventh reaction mixture.

29. The method of claim 28, further comprising removing the ninth solvent under reduced pressure to yield the tetraanionic pincer ligand supported metallacycloalkylene complex (1).

30. The method of any one of the preceding claims, wherein the tetraanionic pincer ligand supported metallacycloalkylene complex is selected from the group of: 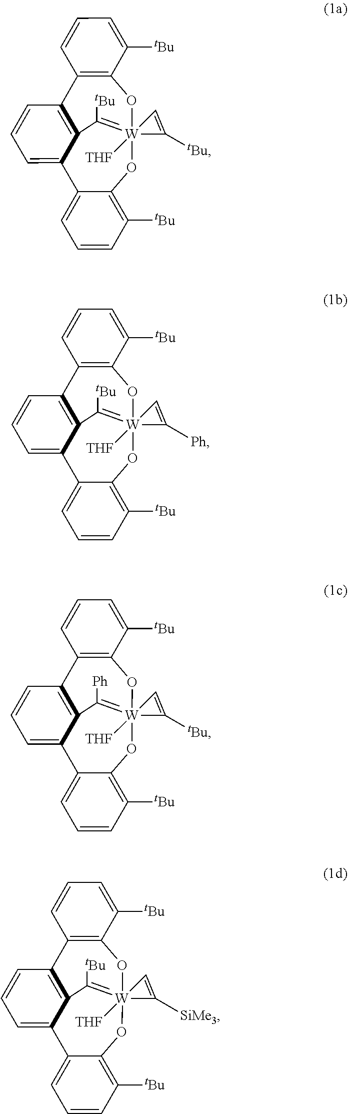
and a combination thereof.

31. A method of preparing a trianionic pincer ligand supported metal-alkylidyne complex (5), comprising:
admixing a second reaction mixture comprising compound (7) and a third solvent to form a third reaction mixture and cooling the third reacting mixture to a third temperature in a range of about −78° C. to about 0° C.;
admixing the third reaction mixture and a base at the third temperature to form a fourth reaction mixture;
warming the fourth reaction mixture to a fourth temperature in a range of about 0° C. to about 80° C. to form a fifth reaction mixture;
removing at least a portion of the third solvent from the fifth reaction mixture to provide a sixth reaction mixture;
washing the sixth reaction mixture with a fifth solvent and removing at least a portion of the fifth solvent to form a seventh reaction mixture;
admixing the seventh reaction mixture with a sixth solvent to provide the eighth reaction mixture;
cooling the eighth reaction mixture to a fifth temperature in a range of about −78° C. to about 0° C. and admixing at the fifth temperature the eighth reaction mixture with a solution of methyl trifluoromethansulfonate (MeOTf) in a seventh solvent to form a ninth reaction mixture; and
warming the ninth reaction mixture to a sixth temperature in a range of about 0° C. to about 80° C.
to form a twelfth reaction mixture comprising the trianionic pincer ligand supported metal-alkylidyne complex (5), wherein compound (7) and trianionic pincer ligand supported metal-alkylidyne complex (5) have the structures:

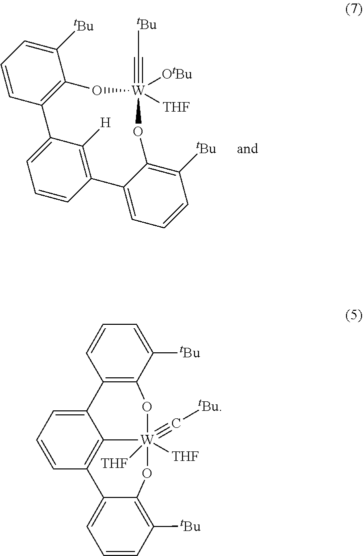

32. The method of claim 31, further comprising preparing the second reaction mixture comprising compound (7), by
admixing at a first temperature in a range of about −78° C. to about 0° C. a solution of [^{t}BuOCO]H₃ compound (2) in a first solvent and a solution of (^{t}BuO)₃W≡CC(CH₃)₃ compound (3) in a second solvent to form a first reaction mixture;
warming the first reaction mixture to a second temperature in a range of about 0° C. to about 80° C.; and
removing at least a portion of the first solvent and the second solvent from the first reaction mixture to provide the second reaction mixture comprising compound (7), wherein compounds (2), and (3) have the structures:

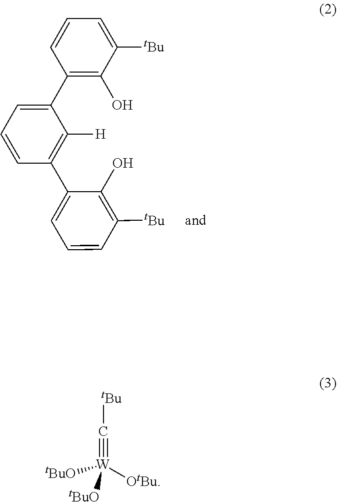

33. The method of claim 32, wherein compound (2) and compound (3) are admixed in a molar ratio in a range of 1:1 to 1:3, 1:1.05 to 1:3, 1:1.05 to 1:2, 1:1.05 to 1:1.5, 1:1.05 to 1:1.25, or 1:1.10 to 1:1.20.

34. The method of claim 32 or claim 33, wherein admixing of compound (2) and compound (3) comprises dropwise addition of the solution of compound (3) to the solution of compound (2).

35. The method of any one of claims 32 to 34, wherein the first solvent is selected from the group of tetrahydrofuran (THF), ethyl ether (Et₂O), 2-methyltetrahydrofuran, 1,4-dioxane, hexanes, benzene, toluene, pentane, and a combination thereof.

36. The method of claim 34, wherein the second solvent is selected from the group of THF, Et₂O, 2-methyltetrahydrofuran, 1,4-dioxane, hexanes, benzene, toluene, pentane, and a combination thereof.

37. The method of any one of claims 32 to 36, wherein warming the first reaction mixture to the second temperature comprises warming the reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

38. The method of any one of claims 32 to 37, wherein removing at least a portion of the first solvent and the second solvent comprises removing the solvents under reduced pressure to form a first solid mixture.

39. The method of claim 38, wherein removing at least a portion of the first solvent and the second solvent further comprises triturating the first solid mixture with pentane one or more times, for example, twice, three times, or four times.

40. The method of any one of claims 31 to 39, wherein the third solvent comprises Et₂O, THF, 2-methyltetrahydrofuran, 1,4-dioxane, hexanes, benzene, toluene, pentane, and a combination thereof.

41. The method of any one of claims 31 to 40, wherein the base comprises a ylide selected from the group of a phosphorus ylide, a sulfonium ylide, a sulfoxonium ylide, a carbonyl ylide, an oxonium ylide, an azomethine ylide, a nitrile ylide, or a combination thereof.

42. The method of any one of claims 31 to 41, wherein the base comprises Ph₃P═CH₂.

43. The method of any one of claims 31 to 42, wherein admixing the base comprises admixing the base in an amount of about 0.5 to about 2 molar equivalences, relative to the amount of compound (2) included in the step of admixing compound (2) and compound (3).

44. The method of any one of claims 31 to 43, wherein the base is provided in solution with a fourth solvent.

45. The method of claim 44, wherein the fourth solvent comprises Et₂O, THF, 2-methyltetrahydrofuran, 1,4-dioxane, hexanes, benzene, toluene, pentane, and a combination thereof.

46. The method of any one of claims 31 to 45, wherein warming the fourth reaction mixture to the fourth temperature comprises warming the fourth reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

47. The method of any one of the claims 31 to 46, wherein admixing the MeOTf and the eighth reaction mixture comprises admixing MeOTf in an amount of about 0.5 to about 2 molar equivalences, relative to the amount of compound (2) included in the step of admixing compound (2) and compound (3).

48. The method of any one of claims 31 to 47, wherein the seventh solvent comprises Et₂O, THF, 2-methyltetrahydrofuran, 1,4-dioxane, dichloromethane (DCM), hexanes, benzene, toluene, pentane, and a combination thereof.

49. The method any one of claims 31 to 48, wherein admixing the eighth reaction mixture with MeOTf comprises dropwise addition of the solution MeOTf to the eighth reaction mixture, with stirring.

50. The method of any one of claims 31 to 49, wherein warming the ninth reaction mixture to the sixth temperature comprises warming the ninth reaction mixture with stirring for a time in a range of about 5 minutes to about 24 hours, about 15 minutes to about 24 hours, about 30 minutes to about 24 hours, about 45 minutes to about 24 hours, about 1 hour to about 24 hours, about 1 hour to about 18 hours, about 1 hour to about 12 hours, about 1 hour to about 10 hours, about 1 hour to about 8 hours, about 1 hour to about 5 hours, about 1 hour to about 4 hours, about 1 hour to about 3 hours, or about 1 hour to about 2 hours.

51. The method of any one of claims 31 to 50, further comprising adding a eighth solvent to the ninth reaction mixture after warming the ninth reaction mixture to the sixth temperature, wherein the solvent is selected from the group of THF, Et₂O, 2-methyltetrahydrofuran, 1,4-dioxane, hexanes, benzene, toluene, pentane, and a combination thereof.

52. The method of any one of claims 31 to 51, further comprising removing at least a portion of the solvents from the twelfth reaction mixture to form a fourth solid mixture.

53. The method of claim 52, wherein removing at least a portion of the solvents from the twelfth reaction mixture comprises removing the solvents under reduced pressure.

54. The method of claim 52 or 53, further comprising re-suspending the solids of the fourth solid mixture in a tenth solvent comprising pentane, hexane, or a combination thereof, and removing any insoluble solids by filtration to form a thirteenth reaction mixture.

55. The method of claim 54, further comprising removing the tenth solvent under reduced pressure to yield trianionic pincer ligand supported metal-alkylidyne complex (5).

56. The method of any one of claim 1 or 31, wherein the fifth solvent comprises pentane, hexane, or a combination thereof.

57. The method of any one of claim 1 or 31, further comprising removing at least a portion of the solvents from the fifth reaction mixture under reduced pressure to form a second solid mixture.

58. The method of any one of claim 1 or 31, further comprising re-suspending the solids of the second solid mixture in the fifth solvent and removing any insoluble solids by filtration to form the seventh reaction mixture.

59. The method of any one of claim 1 or 31, wherein the sixth solvent comprises Et₂O, THF, 2-methyltetrahydrofuran, 1,4-dioxane, hexanes, benzene, toluene, pentane, and a combination thereof.
